(19) United States
(12) Patent Application Publication
(10) Pub. No.: US 2005/0154099 A1
(43) Pub. Date: Jul. 14, 2005

(54) Flame resistant polyester resin compositions

(76) Inventors: Toshikazu Kobayashi, Chadds Frod, PA (US); Hiroyuki Sumi, Tochigi-Ken (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/937,617

(22) Filed: Sep. 8, 2004

Related U.S. Application Data
(60) Provisional application No. 60/501,461, filed on Sep. 8, 2003.

(51) Int. Cl. C08K 5/34; C08K 5/49

(52) U.S. Cl. 524/99; 524/115

(57) ABSTRACT

The present invention relates to flame resistant polyester resin compositions comprising 30 to 90 weight percent thermoplastic polyester; 1 to 30 weight percent oligomeric aromatic phosphate ester; 1 to 25 weight percent phenolic polymer; 1 to 35 weight percent of at least one melamine flame retardant selected from melamine pyrophosphate, melamine phosphate, melamine polyphosphate, melamine cyanurate, and mixtures thereof; and optionally inorganic reinforcing agents. The present invention further relates to molded articles or parts formed from resins comprising such flame resistant polyester resin compositions, and the laser welded articles further produced therefrom.

### CROSS REFERNCE TO RELATED APPLICATIONS

This application claims priority of U.S. Provisional Application No. 60.501,461, filed Sep. 8, 2003.

### FIELD OF THE INVENTION

The present invention relates to a flame resistant polyester resin composition containing a non-halogenated flame retardant. It further relates to flame resistant polyester resin compositions that retain the excellent physical properties and moldability of the base polyester, and can be formed into resins suitable for use in automotive parts, electrical and electronic parts, and machine parts. The present invention further relates to molded articles or parts formed from resins comprising such flame resistant polyester resin compositions, and the laser welded articles further produced therefrom.

### BACKGROUND OF THE INVENTION

Because of their excellent mechanical and electrical insulation properties, thermoplastic polyester resin compositions are used in a broad range of applications such as, for example, automotive parts, electrical and electronic parts, and machine parts. In many of these applications, however, the polyester resin compositions are required to be flame resistant. This requirement has prompted research into a variety of methods for imparting flame resistance to polyester resins.

A common method used to impart flame resistance to thermoplastic polyester resin compositions involves adding a halogenated organic compound as a flame retardant and an antimony compound to act as a synergist for the flame retardant. The use of halogenated flame retardants, however, has certain drawbacks. Specifically, halogenated flame retardants tend to corrode the barrels of compounding extruders, the surfaces of molding machines, and other equipment they come into contact with at elevated temperatures. Some halogenated flame retardants detrimentally effect the electrical properties of the polyester resin compositions into which such retardants are incorporated. Additionally, the high flame retardant loadings required for such flame retardants to be effective can detrimentally effect the mechanical properties of the resins into which such flame retardants are incorporated. Thus, effective non-halogenated flame retardants that do not detrimentally effect a resin's mechanical properties are desirable.

U.S. Pat. No. 5,814,690 discloses a thermoplastic molding composition comprising poly(butylene terephthalate), a reinforcing component, and a mixed flame retardant containing melamine pyrophosphate and an aromatic phosphate oligomer in selected proportions. The large amount of melamine pyrophosphate needed to achieve good levels of flame retardancy, however, detrimentally effected the mechanical properties of the thermoplastic molding compositions being produced.

The present invention involves using a non-halogenated flame retardant system to produce an easily molded flame resistant polyester resin composition having excellent flame retardancy and mechanical properties.

### SUMMARY OF THE INVENTION

The present invention relates to a flame resistant polyester resin composition comprising:
(A) 30 to 90 weight percent thermoplastic polyester;
(B) 1 to 30 weight percent oligomeric aromatic phosphate ester;
(C) 1 to 25 weight percent phenolic polymer; and
(D) 1 to 35 weight percent melamine flame retardant selected from melamine pyrophosphate, melamine phosphate, melamine polyphosphate, melamine cyanurate, and mixtures thereof;
wherein the weight percentage of each of the components (A)-(D) is based on the total weight of components (A)-(D).

The present invention further relates to articles or parts made from the flame resistant polyester resin compositions, and the laser welded articles further produce therefrom.

### BRIEF DESCRIPTION OF THE DRAWINGS

FIG. 1 is a side elevation of test piece 11 used herein to measure weld strength.

FIG. 2 is a top plane view of test piece 11 used herein to measure weld strength.

FIG. 3 is a perspective view of test piece 11 used herein to measure weld strength.

FIG. 4 is a perspective view of relatively transparent test piece 11′, and relatively opaque test piece 11″, wherein the faying surfaces of the respective test pieces are placed into contact and positioned to be laser welded together.

### DETAILED DESCRIPTION OF THE INVENTION

The features and advantages of the present invention will be more readily understood by those of ordinary skill in the art upon reading the following detailed description. It is to be appreciated that certain features of the invention that are, for clarity reasons, described above and below in the context of separate embodiments, may also be combined to form a single embodiment. Conversely, various features of the invention that are, for brevity reasons, described in the context of a single embodiment, may be combined so as to form sub-combinations thereof.

Moreover, unless specifically stated otherwise herein, references made in the singular may also include the plural (for example, “a” and “an” may refer to either one, or one or more). In addition, unless specifically stated otherwise herein, the minimum and maximum values of any of the variously stated numerical ranges used herein are only approximations understood to be preceded by the word “about” so that slight variations above and below the stated ranges can be used to achieve substantially the same results as those values within the stated ranges. Additionally, each of the variously stated ranges are intended to be continuous so as to include every value between the stated minimum and maximum value of each of the ranges.

Further, when an amount, concentration, or other value or parameter is given as a list of upper preferable values and lower preferable values, this is to be understood as specifically disclosing all ranges formed from any pair of an upper preferred value and a lower preferred value, regardless of whether such ranges are separately disclosed.

All patents, patent applications and publications referred to herein are incorporated by reference.

The flame resistant polyester resin composition of the present invention comprises:
(A) 30 to 90 weight percent thermoplastic polyester;
(B) 1 to 30 weight percent oligomeric aromatic phosphate ester;
(C) 1 to 25 weight percent phenolic polymer; and
(D) 1 to 35 weight percent melamine flame retardant selected from melamine pyrophosphate, melamine phosphate, melamine polyphosphate, melamine cyanurate, and mixtures thereof;
wherein the weight percentage of each of the components (A)-(D) is based on the total weight of components (A)-(D).

In general, any thermoplastic polyester may be used as component (A). Mixtures of thermoplastic polyesters and/or thermoplastic polyester copolymers may also be used. The term “thermoplastic polyester” as used herein includes polymers that have an inherent viscosity of 0.3 or greater and are, in general, either linear saturated condensation products of diols and dicarboxylic acids, or reactive derivatives thereof. Preferably, the thermoplastic polyester is a condensation product of an aromatic dicarboxylic acid having 8 to 14 carbon atoms and at least one diol selected from neopentyl glycol, cyclohexanedimethanol, 2,2-dimethyl-1,3-propane diol and aliphatic glycols of the formula HO(CH₂)ₙOH where n is an integer from 2 to 10. The diol may further comprise up to 20 mole percent of an aromatic diol including, for example, ethoxylated bisphenol A, which is sold under the tradename Dianol 220 by Akzo Nobel Chemicals, Inc.; hydroquinone; biphenol; and bisphenol A.

The aromatic dicarboxylic acid having from 8-14 carbon atoms may be replaced by up to 50 mole percent of at least one different aromatic dicarboxylic acid having from 8 to 14 carbon atoms, and/or by up to 20 mole percent of an aliphatic dicarboxylic acid having from 2 to 12 carbon atoms. Copolymers may be prepared from at least two diols or reactive equivalents thereof and at least one dicarboxylic acid having from 8-14 carbon atoms or reactive equivalent thereof, or at least two dicarboxylic acids having from 8-14 carbon atoms or reactive equivalents thereof and at least one diol or reactive equivalent thereof. Difunctional hydroxy acid monomers, such as, for example, hydroxybenzoic acid; hydroxynaphthoic acid, and reactive equivalents thereof may also be used as comonomers.

Preferably, the thermoplastic polyester is a poly(ethylene terephthalate) (PET), poly(1,4-butylene terephthalate) (PBT), poly(propylene terephthalate) (PPT), poly(1,4-butylene naphthalate) (PBN), poly(ethylene naphthalate) (PEN), poly(1,4-cyclohexylene dimethylene terephthalate) (PCT), or copolymers or mixtures thereof. Also preferred are 1,4-cyclohexylene dimethylene terephthalate/isophthalate copolymers and other linear homopolymer esters derived from the condensation product of aromatic dicarboxylic acids having from 8-14 carbon atoms, and at least one diol selected from neopentyl glycol; cyclohexane dimethanol; 2,2-dimethyl-1,3-propane diol; and aliphatic glycols of the general formula HO(CH₂)ₙOH where n is an integer from 2 to 10. The thermoplastic polyester is also preferably selected from random copolymers of at least two of PET, PBT, and PPT; mixtures of at least two of PET, PBT, and PPT; and mixtures of at least one PET, PBT, and PPT with at least one random copolymer of at least two of PET, PBT, and PPT.

Examples of aromatic dicarboxylic acids having from 8-14 carbon atoms, include, but are not limited to, isophthalic acid; bibenzoic acid; naphthalenedicarboxylic acids, including, for example, 1,5-naphthalenedicarboxylic acid, 2,6-naphthalenedicarboxylic acid, and 2,7-naphthalenedicarboxylic acid; 4,4′-diphenylenedicarboxylic acid; bis(p-carboxyphenyl) methane; ethylene-bis-p-benzoic acid; 1,4-tetramethylene bis(p-oxybenzoic) acid; ethylene bis(p-oxybenzoic) acid; 1,3-trimethylene bis(p-oxybenzoic) acid; and 1,4-tetramethylene bis(p-oxybenzoic) acid.

Examples of aliphatic dicarboxylic acids having from 2 to 12 carbon atoms include, but are not limited to, adipic acid, sebacic acid, azelaic acid, dodecanedioic acid, and 1,4-cyclohexanedicarboxylic acid.

Examples of aliphatic glycols of the general formula HO(CH₂)ₙOH where n is an integer from 2 to 10, include, but are not limited to, ethylene glycol, 1,3-trimethylene glycol, 1,4-tetramethylene glycol, 1,6-hexamethylene glycol, 1,8-octamethylene glycol, 1,10-decamethylene glycol, 1,3-propylene glycol, or 1,4-butylene glycol.

More preferably, the thermoplastic polyester is a PET that has an inherent viscosity (IV) of at least about 0.5 at 30° C. in a 3:1 volume ratio mixture of methylene chloride and trifluoroacetic acid. A PET having a higher IV ranging from about 0.80 to about 1.0, however, can be used in applications requiring enhanced mechanical properties such as increased tensile strength and elongation.

The thermoplastic polyester may also be in the form of copolymers that contain poly(alkylene oxide) soft segments. Such copolymers may contain from about 1 to about 15 parts by weight poly(alkylene oxide) soft segments per 100 parts per weight of thermoplastic polyester. The poly(alkylene oxide) soft segments preferably have a number average molecular weight in the range of about 200 to about 3,250, and more preferably in the range of about 600 to about 1,500. Preferred copolymers incorporate poly(ethylene oxide) soft segments into a PET or PBT chain. Methods of incorporation are known to those skilled in the art, such as, for example, using the poly(alkylene oxide) soft segment as a comonomer during the polymerization reaction that forms the polyester. PET may be blended with copolymers of PBT and at least one poly(alkylene oxide). A poly(alkyene oxide) may also be blended with a PET/PBT copolymer. The inclusion of a poly(alkylene oxide) soft segment into the polyester portion of the composition may accelerate the rate of crystallization of the polyester.

Component (B) of the present invention is an oligomeric aromatic phosphate ester flame retardant. The oligomeric aromatic phosphate ester has the general formula (I): 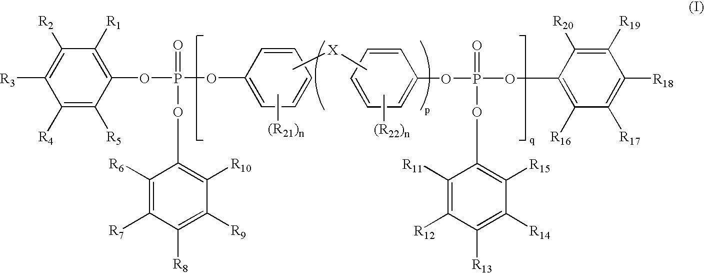
where R₁-R₂₂ are each independently a hydrogen atom or an alkyl group having 1 to 4 carbon atoms, such as, for example, methyl, ethyl, n-propyl, I-propyl, or tert-butyl; X is a—CH₂—, —C(CH₃)₂—, —S—, —SO₂—, —O—, —CO—, or —N═N—; n is a 0, 1, 2, 3, or 4; p is a 0 or 1; and q is an integer between 1 and 16, inclusive.

A more preferred oligomeric aromatic phosphate ester is resorcinol bis(di-2,6-xylyl)phosphate, shown in formula (II), and other preferred aromatic phosphate esters are shown in formulas (III) and (IV).

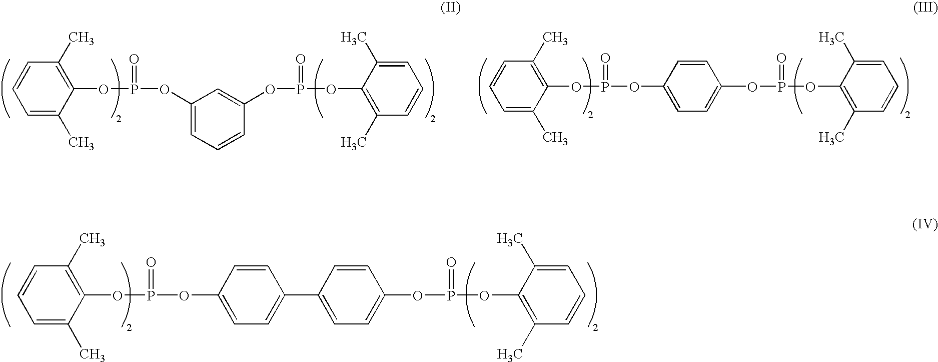

In general, any commercially available phenolic polymer may be used as component (C). The phenolic polymer may include novolacs or resols. The phenolic polymers may be partially or fully cured by being heated and/or by containing a cross-linking agent. The phenolic polymer is preferably a novolac, and more preferably a novolac that is not heat reactive and does not contain a cross-linking agent. The phenolic polymer may be added in any form such as, for example, pulverized; granular; flake; powder; acicular; and liquid. Two or more phenolic polymers may be used as a blend.

At least one method for preparing a novolac involves charging at least one phenol and at least one aldehyde in a molar ratio that ranges from about 1:0.7 to about 1:0.9 to a reactor, adding a catalyst such as, for example, oxalic acid; hydrochloric acid; sulfuric acid; or toluene sulfonic acid to the reactor, heating at reflux reaction for an effective amount of time, removing the water generated by dehydration with a vacuum or by settling, and removing any residual water and unreacted monomers.

At least one method for preparing a resol involves charging at least one phenol and at least one aldehyde in a molar ratio ranging from about 1:1 to about 1:2 to a reactor, adding a catalyst, such as, for example, sodium hydroxide; aqueous ammonia; or other basic material, heating at reflux reaction for an effective amount of time, removing the water generated by dehydration with a vacuum or by settling, and removing any residual water and unreacted monomers.

Phenols suitable for preparing a phenolic polymer include, for example, phenol; o-cresol; m-cresol; p-cresol; thymol; p-tert-butyl phenol; tert-butyl catechol; catechol; isoeugenol; o-methoxy phenol; 4,4′-dihydroxy phenyl-2,2-propane; isoamyl salicylate; benzyl salicylate; methyl salicylate; and 2,6-di-tert-butyl-p-cresol. Adehydes and aldehyde precusors suitable for preparing a phenolic polymer include formaldehyde; paraformaldehyde; polyoxymethylene; and trioxane. More than one aldehyde and/or phenol may be used in the preparation of the phenolic polymer. The phenolic polymer used in this invention should have a weight loss of preferably not more than 50%, and more preferably not more than 40%, when a sample of about 10 mg of powdered polymer is heated at a rate of 40° C./min in air to 500° C. in a simultaneous differential thermal and thermogravimetric measurement device (such as the TG/DTA-200 made by Seiko Electronics Industry Co.).

Although there is no particular limitation as to the molecular weight of the phenolic polymer, the phenolic polymer preferably has a number average molecular weight of about 200 to about 2,000, and more preferably of about 400 to about 1,500. The molecular weight of a phenolic polymer may be determined by gel permeation chromatography using a tetrahydrofuran solution against a polystyrene standard sample.

Component (D) of the present invention is a melamine flame retardant. The melamine flame retardant includes, for example, melamine pyrophosphate ((C₃H₆N₆)₂.H₄P₂O₇); melamine phosphate (C₃H₆N₆.HPO₃); melamine polyphosphate (C₃H₆N₆.HPO₃)ₙ, where n>2; melamine cyanurate (C₃H₆N₆.C₃H₃N₃O₃); and mixtures thereof. Melamine polyphosphate can be prepared by heating melamine pyrophosphate under nitrogen at 290° C. to constant weight. Commercially available melamine flame retardants may contain substantial impurities in terms of having different ratios of phosphorous to nitrogen and/or having other phosphorous containing anions present. Nevertheless, the commercially available flame retardants are intended to be included within the scope of the present invention. Preferably, component (D) is melamine pyrophosphate.

The present flame resistant polyester resin composition contains from about 30 to about 90 weight percent component (A), from about 1 to about 30 weight percent component (B), from about 1 to about 25 weight percent component (C), and from about 1 to about 35 weight percent component (D), wherein the weight percentage of each of the components (A)-(D) is based on the total weight of components (A), (B), (C), and (D). Preferably, the combined amount of components (B) and (D) ranges from about 10 to about 40 weight percent, based on the total weight of components (A), (B), (C), and (D). In addition, the ratio of the combined weight of components (B) and (D) to the weight of (C) preferably ranges from about 0.5:1 to about 40:1, more preferably from about 1:1 to about 30:1; and most preferably from about 1.25:1 to about 18:1.

Components (B), (C), and (D) are all necessary to impart excellent flame retardancy, good mechanical properties, and good moldability to the compositions of the present invention. Preferably, the compositions of the present invention are V-0 flame retardant when subjected to UL Test No. UL-94 (20 mm Vertical Burning Test) using 1/16^{th} inch and ⅛^{th} inch thick test pieces.

The compositions of the present invention may further comprise about 10 to about 120 parts by weight of at least one inorganic reinforcing agent per 100 parts by weight of the combined amount of components (A), (B), (C), and (D). The inorganic reinforcing agents may include known reinforcing agents such as, for example, glass fibers; glass flakes; mica; whiskers; talc; calcium carbonate; synthetic resin fibers, and mixtures thereof. A molded article that is warped and has poor surface appearance will be produced when an inorganic reinforcing agent is added in an amount that exceeds 120 parts by weight.

The compositions of the present invention may also optionally contain a plasticizer, such as, for example, poly(ethylene glycol) 400 bis(2-ethyl hexanoate); methoxypoly(ethylene glycol) 550 (2-ethyl hexanoate); and tetra(ethylene glycol) bis(2-ethyl hexanoate).

The compositions of the present invention may also optionally contain a nucleating agent, such as, for example, a sodium or potassium salt of a carboxylated organic polymer; the sodium salt of a long chain fatty acid; and sodium benzoate. Part or all of the polyester may be replaced with a polyester that has at least some end groups that have been neutralized with sodium or potassium.

The compositions of the present invention may also contain, in addition to the above components, additives, such as, for example, heat stabilizers; antioxidants; dyes; pigments; mold release agents; UV stabilizers; and mixtures thereof, provided such additives do not negatively impact the physical properties or flame resistance of the compositions.

The compositions of the present invention are melt-mixed blends, wherein all of the polymeric components are well-dispersed within each other and all of the non-polymeric ingredients are homogeneously dispersed in and bound by the polymer matrix, such that the blend forms a unified whole. Any melt-mixing method may be used to combine the polymeric components and non-polymeric ingredients of the present invention.

For example, the polymeric components and non-polymeric ingredients may be added to a melt mixer, such as, for example, a single or twin-screw extruder; a blender; a kneader; or a Banbury mixer, either all at once through a single step addition, or in a step-wise fashion, and then melt-mixed until homogenous. When adding the polymeric components and non-polymeric ingredients in a step-wise fashion, part of the polymeric components and/or non-polymeric ingredients are first added and melt-mixed with the remaining polymeric components and non-polymeric ingredients being subsequently added and further melt-mixed until a homogeneous composition is obtained.

The order in which the polymeric components and non-polymeric ingredients of the present composition are mixed can, for example, be such that the polymeric components and non-polymeric ingredients are all fed into the rear of the extruder. In the alternative, at least portions of the non-polymeric ingredients, such as, for example, the filler, melamine flame retardant and/or oligomeric aromatic phosphate ester can be side-fed while the majority of the polymeric component and the remainder of the non-polymeric ingredients are fed into the rear of the extruder. A person of ordinary skill in the art is familiar with the order and manner in which the polymeric components and non-polymeric ingredients of the present invention can be mixed, and therefore readily understands how to obtain the melt-mixed blends of the present invention.

The composition of the present invention may be formed into articles using methods known to those skilled in the art, such as, for example, injection molding; blow molding; or extrusion. Such articles can include those for use in electrical and electronic applications, mechanical machine parts, and automotive applications. Articles for use in applications requiring a high degree of flame resistance are preferred.

The compositions of the present invention can be used to make articles/parts that can be laser welded to other polymeric articles/parts so as to form further articles that include, for example, electrical housings; electronic housings; and parts for office equipment, such as, for example, printers. As is well-known in the art of laser welding, one of the articles/parts being joined is relatively transparent to the wavelength of light used for laser welding and the other is relatively opaque. The relatively opaque article/part is able to absorb sufficient energy at the wavelength used for laser welding to melt the plastic at the interface between the articles/parts so as to bond the articles/parts together.

A relatively transparent article/part comprising the composition of the present invention may have a natural color or may contain dyes that are sufficiently transparent to the wavelength of light used for laser welding. Such dyes may include, for example, anthraquinone-based dyes. A relatively opaque article/part comprising the composition of the present invention may be rendered sufficiently opaque by preferably containing a dye or pigment, such as, for example, carbon black or nigrosine.

The relatively transparent articles or parts and the relatively opaque articles or parts that are being laser welded together may all be molded from resins comprising the compositions of the present invention. In the alternative, only the relatively transparent articles or parts, or only the relatively opaque articles or parts may be molded from resins comprising the compositions of the present invention, wherein the other articles or parts may be molded from resins comprising compositions that comprise a polyester or other suitable thermoplastic polymer.

### EXAMPLES

The resin of each example was formed by first premixing the respective quantites of each of the ingredients set forth in Tables 1 and 2 for 20 minutes in a tumbler, and then melt compounding the mixture in a 40 mm ZSK Werner & Pfleiderer twin screw extruder with 9 barrels at a temperature of 270° C. and operating at 250 RPM. The glass fiber, melamine pyrophosphate, and novolac were fed to the extruder at a point after the polymer melting zone, and the PX-200 was fed to the extruder at a point after the glass fiber, melamine pyrophosphate, and novolac. The other ingredients were fed at the rear of the extruder. Upon exiting the extruder, the polymer was passed through a die to form strands that were frozen in a quench tank and then chopped to make pellets.

The resulting resins were used to mold 13 mm×130 mm×3.2 mm tensile bars according to ASTM D638. The tensile bars were used to measure mechanical properties. The following test procedures were used:

| | |
|---|---|
| Tensile strength: | ASTM D638-58T |
| Elongation at break: | ASTM D638-58T |
| Flexural modulus and strength: | ASTM D790-58T |
| Notched and unnotched Izod impact strength: | ASTM D256 |
| Heat deflection temperature (HTD): | ASTM D648 |

The resulting resins were also used to mold the 1/16^{th} inch (referred to in Tables 1 and 2 as 1.6 mm) and the ⅛^{th} inch (referred to in Tables 1 and 2 as 0.8 mm) thick test pieces used to measure flame retardance. The Flame retardance testing was done according to UL Test No. UL-94 (20 mm Vertical Burning Test). Prior to being subjected to flammability testing, the test pieces were conditioned for either 48 hours at 23° C. and 50% relative humidity, or 168 hours at 70° C. The results are referred to in Tables 1 and 2 as “Flame retardance 23° C./48 hr” and “Flame retardance 70° C./168 hr”, respectively. A resin was considered to have excellent flame retardance if the resin of both the 0.8 mm and 1.6 mm test pieces was found to have a V-0 flame retardance.

Ejectability was determined by observing the ease with which a 13 mm×130 mm×3.2 mm tensile bar molded according to ASTM D638 from the resins yielded by the Table 1 and 2 compositions was ejected from the mold of a molding machine. Tensile bars that were easily ejected from the mold of the molding machine are listed in Table 1 as “OK”. Tensile bars that got stuck in the mold of the molding machine are listed in Table 1 as “sticks”.

Laser Weld Strength

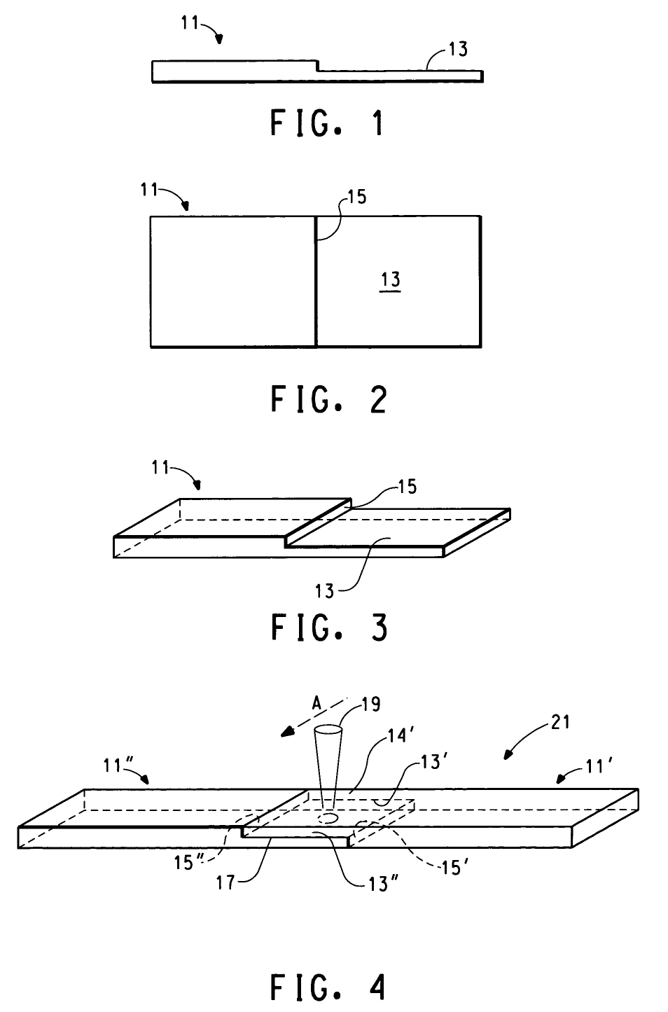

FIGS. 1-3 disclose the geometry of a typical test piece 11 that was used to measure the weld strength as reported herein. Test piece 11 was generally rectangular in shape, having dimensions of 70 mm×18 mm×3 mm and a 20 mm deep half lap at one end. The half lap is defined by faying surface 13 and riser 15.

In FIG. 4, test piece 11′ is a relatively transparent polymeric test piece and test piece 11″ is a relatively opaque polymeric test piece. The faying surfaces 13′ and 13″ of test pieces 11′ and 11″, respectively, were placed into contact so as to form juncture 17 therebetween. Relatively transparent test piece 11′ defines an impinging surface 14′ that is impinged by laser radiation 19 moving in the direction of arrow A. Laser radiation 19 passed through relatively transparent test piece 11′ and irradiated the faying surface 13″ of relatively opaque test piece 11″ and thereby caused pieces 11′ and 11″ to be welded together at juncture 17 so as to form test bar 21.

In accordance with the invention, a resin comprised of the composition disclosed in Example 3 was dried and molded into Example 3 test piece 11′, which was conditioned at 23° C. and 65% relative humidity for 24 hours. By way of comparison, resins comprised of the Comparative Example 7 and 8 compositions, which are outside the scope of the present invention, were molded into Comparative Example 7 test piece 11′ and Comparative Example 8 test piece 11′. Crastin® SK605 BK, which is a 30% glass reinforced PBT containing carbon black manufactured by E.I. DuPont de Nemours, Inc. Wilmington, Del., was dried and molded into relatively opaque Crastin® SK605 BK test piece 11″.

An Example 3 test piece 11′ and a relatively opaque Crastin® SK605 BK test piece 11″ were laser welded together, as already described hereinabove, with a clamped pressure of 0.3 MPa to form Example 3 test bar 21. In addition, a Comparative Example 7 test piece 11′ and a Comparative Example 8 test piece 11′ were each separately laser welded, as already described hereinabove, to a relatively opaque Crastin® SK605 BK test piece 11″ with a clamped pressure of 0.3 MPa to form separate Comparative Example 7 test bar 21 and Comparative Example 8 test bar 21.

The laser radiation was emitted from a Rofin-Sinar Laser GmbH 940 nm diode laser that operated at the power identified in Table 2. The laser was passed across the width of test pieces 11′ and 11″ at a rate of 200 cm/min one time. After welding, the resulting test bars were further conditioned for 24 hours at 23° C. and 65% relative humidity. The force required to separate the 11′ and 11″ test pieces of the Example 3, Comparative Example 7 and Comparative Example 8 test bars was determined using an Instron® tester clamped at the shoulder of the test bars, wherein tensile force was applied in the longitudinal direction of the Example 3, Comparative Example 7 and Comparative Example 8 test bars 21. The Instron® tester was operated at a rate of 2 mm/min. The results are given in Table 2 as “laser weld strength.”

The Example 1 and 2 compositions yielded resins having excellent flame retardance and good mechanical properties. The resins yielded by the Example 1 and 2 compositions were easily ejected from the molding machine molds. Comparative Example 1 indicates that compositions containing a thermoplastic polyester, an oligomeric aromatic phosphate ester, and a melamine flame retardant but not a novolac will produce resins having poor flame retardance. Comparative Example 2 indicates that compositions containing a thermoplastic polyester, a phenolic polymer, and a melamine flame retardant but not an oligomeric aromatic phosphate ester will produce resins having poor flame retardance, reduced tensile strength, and reduced heat deflection temperature. Comparative Example 3 indicates that compositions containing a thermoplastic polyester, an oligomeric aromatic phosphate ester, and a phenolic polymer but not a melamine pyrophosphate will produce resins that do not have excellent flame retardance, have reduced tensile strength, have reduced heat deflection temperature, and have poor ejectibility. Comparative Example 4 indicates that compositions containing a thermoplastic polyester and a melamine flame retardant but not an oligomeric aromatic phosphate ester and a phenolic polymer will degrade in the extruder and not be capable of producing resins that can be molded and tested. Comparative Example 5 indicates that compositions containing a thermoplastic polyester and an oligomeric aromatic phosphate ester but not a phenolic polymer and a melamine pyrophosphate will produce resins having very poor flame retardancy, reduced tensile strength, reduced heat deflection temperature, and poor ejectibility. Comparative Example 6 indicates that compositions containing a thermoplastic polyester and a phenolic polymer but not an oligomeric aromatic phosphate ester and a melamine pyrophophate will fail the UL-94 Flame Retardancy test.

Example 3 indicates that parts made from resins produced from compositions of the present invention can be laser welded to a relatively opaque part via a strong weld to produce further articles that have a V-0 flame retardance. Comparative Example 7 indicates that although parts produced from resins that do not contain a melamine flame retardant in accordance with the present invention can be laser welded to a relatively opaque part via a strong weld to produce further articles, such further articles fail the UL-94 flame retardancy test. Comparative Example 8 indicates that although parts made from resins produced from compositions containing a thermoplastic polymer, a traditional brominated polystyrene flame retardant, and an antimony trioxide synergist have a V-0 flame retardance, such parts cannot be successfully laser welded to a relatively opaque part. Attempts to weld Comparative Example 8 parts to relatively opaque parts were conducted at laser powers of between 160 to 200 W with no success.

TABLE 1

| | | | Comp. | Comp. | Comp. | Comp. | Comp. | Comp. |
|---|---|---|---|---|---|---|---|---|
| INGREDIENTS* | Ex. 1 | Ex. 2 | Ex. 1 | Ex. 2 | Ex. 3 | Ex. 4 | Ex. 5 | Ex. 6 |
| PET¹ | 35.1 | 36.10 | 36 | 36 | 36 | 35.8 | 35.8 | 35.1 |
| PX-200² | 13 | 13 | 15 | — | 23 | — | 28 | — |
| Novolac³ | 5 | 5 | — | 10 | 5 | — | — | 28 |
| Melamine | 10 | 7 | 13 | 18 | — | 28 | — | — |
| pyrophosphate⁴ | | | | | | | | |
| Glass fibers A⁵ | 33 | — | — | — | — | — | — | 33 |
| Glass fibers B⁶ | — | 30 | 33 | 33 | 33 | 33 | 33 | — |
| Hostamont ® NAV | 0.3 | 0.3 | 0.2 | 0.2 | 0.2 | 0.2 | 0.2 | 0.3 |
| 101⁷ | | | | | | | | |
| Loxiol ® VPG 861⁸ | 1.3 | 1.3 | 1.0 | 1.0 | 1.0 | 1.0 | 1.0 | 1.3 |
| Epikote ® 1009T⁹ | 0.6 | 0.6 | 0.6 | 0.6 | 0.6 | 0.6 | 0.6 | 0.6 |
| Irganox ® 1010FP¹⁰ | 0.2 | 0.2 | 0.2 | 0.2 | 0.2 | 0.2 | 0.2 | 0.2 |
| Carbon black¹¹ | 1.3 | 1.3 | 1.0 | 1.0 | 1.0 | 1.0 | 1.0 | 1.3 |
| Weston ® 619G¹² | 0.2 | 0.2 | — | — | — | — | — | 0.2 |
| Epon ® 1002F¹³ | — | — | — | — | — | 0.2 | 0.2 | — |
| Talc¹⁴ | — | 5 | — | — | — | — | — | — |
| MECHANICAL | | | | | | | | |
| PROPERTIES | | | | | | | | |
| Tensile strength | 102 | 111 | 125 | 94 | 99 | N/m** | 86 | 101 |
| (MPa) | | | | | | | | |
| Elongation at break | 1.2 | 1.6 | 1.5 | 1.1 | 1.7 | N/m** | 1.6 | 1.1 |
| (%) | | | | | | | | |
| Flexural strength | 147 | 168 | 193 | 151 | 165 | N/m** | 118 | 125 |
| (MPa) | | | | | | | | |
| Flexural modulus | 12243 | 11270 | 11900 | 9367 | 9250 | N/m** | 9158 | 12533 |
| (MPa) | | | | | | | | |
| Notched Izod impact | 62 | 55 | 72 | 80 | 66 | N/m** | 58 | 51 |
| strength (J/m) | | | | | | | | |
| Unnotched Izod | 230 | 241 | 519 | 124 | 384 | N/m** | 402 | 98 |
| impact strength (J/m) | | | | | | | | |
| Heat deflection | 208 | 207 | 185 | 167 | 162 | N/m** | 165 | 167 |
| temperature (° C.) | | | | | | | | |
| FLAME RETARDANCE | | | | | | | | |
| 23° C./48 hr | | | | | | | | |
| 0.8 mm | V-0 | V-0 | V-2 | V-2 | V-0 | N/m** | Fail | Fail |
| 1.6 mm | V-0 | V-0 | V-0 | V-0 | V-0 | N/m** | V-2 | Fail |
| FLAME RETARDANCE | | | | | | | | |
| 70° C./168 hr | | | | | | | | |
| 0.8 mm | V-0 | V-0 | V-2 | V-2 | V-1 | N/m** | Fail | Fail |
| 1.6 mm | V-0 | V-0 | V-0 | V-2 | V-0 | N/m** | V-2 | Fail |
| EJECTABILITY | OK | OK | OK | OK | Sticks | N/m** | Sticks | Sticks |

*All ingredient quantities are given in weight percent relative to the total weight of the composition.
**N/m means not measured.
¹“PET” is a poly(ethylene terephthalate) with an inherent viscosity of about 0.85-0.92 manufactured by Takayasu Inc., Tokyo, Japan and sold as DT-85.
²“PX-200” is resorcinol bis(di-2,6-xylyl)phosphate manufactured by Daihachi Chemicals Co.
³“Novolac” is a polymer prepared from phenol and formaldehyde, wherein the polymer has a number average molecular weight of about 1060.
⁴“Melamine pyrophosphate” is MelBan 1110 manufactured by Hummel Croton, Inc., South Plainfield, NJ.
⁵“Glass fibers A” are NEG D187H glass fibers manufactured by Nippon Electric Glass, Osaka, Japan.
⁶“Glass fibers B” are CS JA FT 592 glass fibers manufactured by Asahi Fiber Glass, Tokyo, Japan.
⁷“Hostamont ® NAV 101” is sodium montanate manufactured by Clariant, Muttenz, Switzerland.
⁸“Loxiol ® VPG 861” is pentaerythritol tetrastearate, manufactured by Cognis, Dusseldorf, Germany.
⁹“Epikote ® 1009T” is an epichlorohydrin/bisphenol A condensation product manufactured by Japan Epoxy Resin Tokyo, Japan.
¹⁰“Irganox ® 1010FP” is an antioxidant manufactured by Ciba Specialty Chemicals, Inc., Tarrytown, NY.
¹¹“Carbon black” is Cabot PE3324, which is carbon black in a polyethylene carrier, manufactured by Cabot Corp., Boston, MA.
¹²“Weston ® 619G” is a phosphite manufactured by GE Specialty Chemicals, Morgantown, W.Va.
¹³“Epon ® 1002F” is a bisphenol A/epichlorohydrin based epoxy resin manufactured by Resolution Performance Products, Houston, TX.
¹⁴“Talc” is Talc FFR manufactured by Asada Seifun, Japan.

TABLE 2

| | | Comp. | Comp. |
|---|---|---|---|
| INGREDIENTS* | Ex. 3 | Ex. 7 | Ex. 8 |
| PBT¹ | 40.5 | 48.8 | 48.8 |
| PX-200² | 13 | 15 | — |
| Novolac³ | 5 | 5 | — |
| Melamine pyrophosphate⁴ | 10 | — | — |
| Halogenated flame redardant⁵ | — | — | 15 |
| Glass fibers C⁶ | 30 | 30 | 30 |
| Loxiol ® VPG 861⁷ | 0.6 | 0.6 | 0.6 |
| Irganox ® 1010FP⁸ | 0.2 | 0.2 | 0.2 |
| Weston ® 619G⁹ | 0.3 | — | — |
| EHPE 3150¹⁰ | 0.4 | 0.4 | 0.4 |
| Antimony trioxide¹¹ | — | — | 5 |
| MECHANICAL PROPERTIES | | | |
| Tensile strength (MPa) | 107 | 108 | 135 |
| Elongation at break (%) | 1.9 | 2 | 1.8 |
| Flexural strength (MPa) | 160 | 163 | 217 |
| Flexural modulus (MPa) | 8390 | 7338 | 10782 |
| Notched Izod impact strength (kJ/m²) | 8 | 9 | 11 |
| Unnotched Izod impact strength (kJ/m²) | 23 | 29 | 46 |
| Heat deflection temperature (° C.) | 190 | 194 | 208 |
| FLAME RETARDANCE 23° C./48 hr | | | |
| 0.8 mm | V-0 | Fail | V-0 |
| 1.6 mm | V-0 | Fail | V-0 |
| LASER WELDING | | | |
| Laser power (W) | 120 | 150 | 160-200 |
| Laser weld strength (kgf) | 92 | 95 | 0 |

*All ingredient quantities are given in weight percent relative to the total weight of the composition.
¹“PBT” is poly(butylene terephthalate) with an inherent viscosity of about 0.82 manufactured by E.I. du Pont de Neumours and Co., Wilmington, DE.
²“PX-200” is resorcinol bis(di-2,6-xylyl)phosphate manufactured by Daihachi Chemicals Co.
³“Novolac” is a polymer prepared from phenol and formaldehyde, wherein the polymer has a number average molecular weight of about 1060.
⁴“Melamine pyrophosphate” is MelBan 1110 manufactured by Hummel Croton, Inc., South Plainfield, NJ.
⁵“Halogenated flame retardant” is Saytex ® HP7010G, a brominated polystyrene manufactured by Albemarle Corp., Baton Rouge, LA.
⁶“Glass fibers C” are FT689 glass fibers manufactured by Asahi Fiber Glass, Tokyo, Japan.
⁷“Loxiol ® VPG 861” is pentaerythritol tetrastearate, manufactured by Cognis, Dusseldorf, Germany.
⁸“Irganox ® 1010FP” is an antioxidant manufactured by Ciba Specialty Chemicals, Inc., Tarrytown, NY.
⁹Weston ® 619G” is a phosphite manufactured by GE Specialty Chemicals, Morgantown, W.Va.
¹⁰“EHPE 3150” is an epoxy resin manufactured by Daicel Chemical Co., Tokyo, Japan.
¹¹“Antimony trioxide” is a masterbatch of 80 wt. % antimony trioxide in 20 wt. % polyethylene.

1. A flame resistant polyester resin composition comprising:
(A) 30 to 90 weight percent thermoplastic polyester;
(B) 1 to 30 weight percent oligomeric aromatic phosphate ester;
(C) 1 to 25 weight percent phenolic polymer; and
(D) 1 to 35 weight percent of at least one melamine flame retardant selected from melamine pyrophosphate, melamine phosphate, melamine polyphosphate, melamine cyanurate, and mixtures thereof;
wherein the weight percentage of each of the components (A)-(D) is based on the total weight of components (A)-(D).

2. The polyester resin composition of claim 1, further comprising about 10 to about 120 parts by weight of an inorganic reinforcing agent per 100 parts by weight of the sum of the components (A), (B), (C), and (D).

3. The polyester resin composition of claim 2, wherein the inorganic reinforcing agent is selected from glass fibers, glass flakes, mica, whiskers, talc, calcium carbonate, synthetic resin fibers, and mixtures thereof.

4. The polyester resin composition of claim 2 wherein the phenolic polymer is a novolac.

5. The polyester resin composition of claim 4 wherein the oligomeric phosphate ester is resorcinol bis(di-2,6-xylyl)phosphate.

6. The polyester resin composition of claim 5 wherein the thermoplastic polyester is selected from poly(ethylene terephthalate) (PET); poly(1,4 butylene terephthalate) (PBT); poly(propylene terephthalate) (PPT); poly(1,4-cyclohexylene dimethylene terephthalate) (PCT); and mixtures thereof.

7. The polyester resin composition of claim 2 wherein the oligomeric phosphate ester is resorcinol bis(di-2,6-xylyl)phosphate.

8. The polyester resin composition of claim 2 wherein the thermoplastic polyester is selected from poly(ethylene terephthalate) (PET), poly(1,4-butylene terephthalate) (PBT), poly(propylene terephthalate) (PPT), poly(1,4-cyclohexylene dimethylene terephthalate) (PCT), copolymers of at least two of PET, PBT, PPT, and PCT, and mixtures thereof.

9. The polyester resin composition of claim 1 wherein the phenolic polymer is a novolac.

10. The polyester resin composition of claim 9, wherein the oligomeric phosphate ester is resorcinol bis(di-2,6-xylyl)phosphate.

11. The polyester resin composition of claim 1 wherein the oligomeric phosphate ester is resorcinol bis(di-2,6-xylyl)phosphate.

12. The polyester resin composition of claim 1, wherein the thermoplastic polyester is selected from poly(ethylene terephthalate) (PET), poly(1,4-butylene terephthalate) (PBT), poly(propylene terephthalate) (PPT), poly(1,4-cyclohexylene dimethylene terephthalate) (PCT), and mixtures thereof.

13. The polyester resin composition of claim 1, wherein the combined amount of components (B) and (D) ranges from about 10 to about 40 weight percent, based on the total weight of components (A), (B), (C), and (D).

14. The polyester resin composition of claim 13, wherein the ratio of the combined weight of components (B) and (D) to the weight of (C) preferably ranges from about 0.5:1 to about 40:1.

15. The polyester resin composition of claim 1, wherein the ratio of the combined weight of components (B) and (D) to the weight of (C) preferably ranges from about 0.5:1 to about 40:1.

16. The polyester resin composition of claim 15, wherein the ratio ranges from about 1:1 to about 30:1.

17. The polyester resin composition of claim 15, wherein the ratio ranges from about 1.25:1 to about 18:1.

18. A molded article comprising the polyester resin composition of claim 1.

19. A molded article comprising the polyester resin composition of claim 2.

20. A molded article comprising the polyester resin composition of claim 6.

21. A laser welded article comprising the molded article of claim 18.

22. A laser welded article comprising the molded article of claim 19.

23. A laser welded article comprising the molded article of claim 20.
